(19) United States
(12) Patent Application Publication
(10) Pub. No.: US 2019/0233571 A1
(43) Pub. Date: Aug. 1, 2019

(54) Composition Suitable for Preparing Polyurethane- or Polyisocyanurate Rigid Foams

(71) Applicant: Evonik Degussa GmbH, Essen (DE)

(72) Inventors: Jörg Diendorf, Essen (DE); Robert Tauchen, Richmond, VA (US); Wiley Rowe, Richmond, VA (US); Carsten Schiller, Ratingen (DE); Christian Eilbracht, Herne (DE)

(73) Assignee: Evonik Degussa GmbH, Essen (DE)

(21) Appl. No.: 16/312,315

(22) PCT Filed: Jun. 8, 2017
(86) PCT No.: PCT/EP2017/063947

§ 371 Date: Dec. 21, 2018

Related U.S. Application Data
(60) Provisional application No. 62/353,704, filed on Jun. 23, 2016.

(51) Int. Cl. C08G 18/09; C08G 18/08; C08G 18/61; C08G 18/42; C08G 18/18; C08G 18/24; C08G 18/76; C08K 5/02

(52) U.S. Cl. CPC C08G 18/092; C08G 18/14; C08G 18/61; C08G 18/4208; C08G 2101/0025; C08G 18/248; C08G 18/7664; C08K 5/02; C08G 18/1808

(57) ABSTRACT

A process for producing polyurethane foam by reacting at least one polyol component with at least one isocyanate component in the presence of at least one blowing agent and of one or more catalysts that catalyze the isocyanate-polyol and/or isocyanate-water reactions and/or the isocyanate trimerization, wherein the reaction is conducted in the presence of selected polyether-siloxane copolymers, is described.

The invention is in the field of polyurethane foams and/or polyisocyanurate foams, especially rigid polyurethane foams and/or polyisocyanurate foams, and of the polyether siloxanes. It relates to a process for producing polyurethane and/or polyisocyanurate foams, preferably rigid polyurethane and/or polyisocyanurate foams, and to foams obtainable by said process, especially rigid foams, and to the use thereof. It further relates to the use of polyether siloxanes in the production of polyurethane and/or polyisocyanurate foams, preferably rigid polyurethane and/or polyisocyanurate foams, and to a method of reducing the thermal conductivity of polyurethane or/and polyisocyanurate foams, preferably rigid foams.

Rigid polyurethane and polyisocyanurate foams are usually produced using cell-stabilizing additives to ensure a fine-celled, uniform and low-defect foam structure and hence to exert an essentially positive influence on the performance characteristics, particularly the thermal insulation performance, of the rigid foam. Surfactants based on polyether-modified siloxanes are particularly effective and therefore represent the preferred type of foam stabilizers. Various publications already describe such foam stabilizers for rigid foam applications.

EP 0570174 A1 describes a polyether siloxane of the structure (CH₃)₃SiO[SiO(CH₃)₂]ₓ [SiO(CH₃)R]_{y}Si(CH₃)₃, the R radicals of which consist of a polyethylene oxide linked to the siloxane through an SiC bond and which is end-capped at the other end of the chain by a C₁-C₆ acyl group. This foam stabilizer is suitable for producing rigid polyurethane foams using organic blowing agents, particularly chlorofluorocarbons such as CFC-11.

The next generation of chlorofluorocarbon blowing agents are hydrochlorofluorocarbons such as HCFC-123 for example. When these blowing agents are used for rigid polyurethane foam production, it is polyether siloxanes of the structural type (CH₃)₃SiO[SiO(CH₃)₂]ₓ[SiO(CH₃)R]_{y}Si(CH₃)₃ which are suitable according to EP 0533202 A1. The R radicals therein consist of SiC-bonded polyalkylene oxides which are assembled from propylene oxide and ethylene oxide and can have a hydroxyl, methoxy or acyloxy function at the end of the chain. The minimum proportion of ethylene oxide in the polyether is 25 per cent by mass.

EP 0877045 A1 describes analogous structures for this production process which differ from the first-named foam stabilizers in that they have a comparatively higher molecular weight and have a combination of two polyether substituents on the siloxane chain.

For the use of halogen-free blowing agents such as hydrocarbons, EP 1544235 A1, for example, describes the production of rigid polyurethane foams using polyether siloxanes of the already known structure (CH₃)₃SiO[SiO(CH₃)₂]ₓ[SiO(CH₃)R]_{y}Si(CH₃)₃ having a minimum chain length for the siloxane of 60 monomer units and different polyether substituents R, the blend average molecular weight of which is in the range from 450 to 1000 g/mol and the ethylene oxide fraction of which is in the range from 70 to 100 mol %.

DE 102006030531 A1 describes the use as foam stabilizers of polyether siloxanes in which the end group of the polyethers is either a free OH group or an alkyl ether group (preferably methyl) or an ester. Particular preference is given to using such polyether siloxanes which have free OH functions. The use of the specific polyether siloxanes is said to exert a positive influence on the fire behaviour in particular.

As mentioned, the use of foam stabilizers serves to improve the performance characteristics of polyurethane foams, for example their insulation performance and their surface characteristics. It is fundamentally the case that one of the factors that affects the insulation performance of the foams is the ambient or use temperature. The thermal conductivity λ (typically reported in W/m˜K) here is temperature-dependent and is generally lower at lower temperature than at higher temperature, meaning that better insulation performance is achieved. The dependence of the thermal conductivity on temperature is virtually linear. However, this temperature-dependent improvement is limited especially in the case of the insulation foams, since an increase in thermal conductivity in turn, i.e. a decrease in insulation performance, is also observed under some circumstances given a sufficiently low temperature. This can already occur at moderately low temperatures as typically occur, for example, in refrigerators. This can be even more critical, for example, in the case of insulation panels that are exposed to cold weather conditions and hence more significant cooling effects.

This observation may possibly be attributable to condensation effects of the blowing agents used that are normally in gaseous form in the foam cells at low temperatures. These effects depend in turn on the nature and composition of the blowing agent used, on the foam density and on further factors, some of them unknown. The correlations seem to be extremely complex.

It is at least usually the case that the thermal conductivity at first has a minimum going from high to low temperatures, i.e. a reduction in the λ value. Subsequently, in the direction of even lower temperatures, the curve rises again, resulting in ever higher λ values.

It is fundamentally desirable to obtain a foam having further-improved insulation properties at lower temperatures.

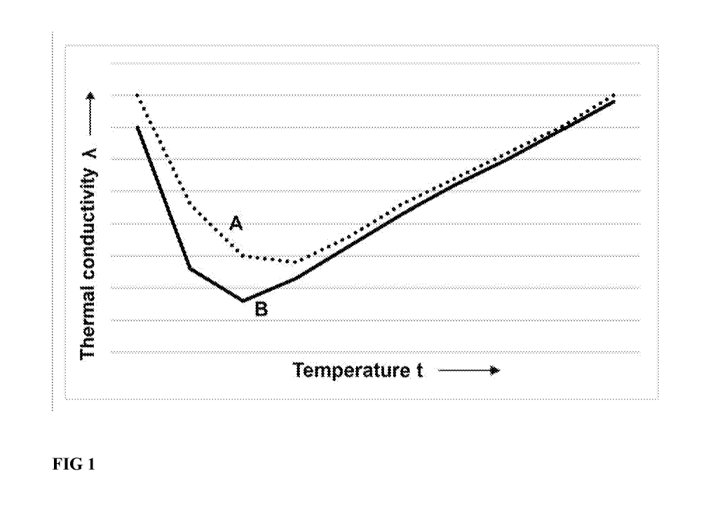

FIG. 1 shows the typical plot of thermal conductivity λ against temperature for a standard PU foam (dotted line; A). The solid line (B) shows the desired plot with a lower λ value in the region of lower temperatures.

The problem addressed was therefore that of providing polyurethane or polyisocyanurate foams, especially rigid polyurethane or polyisocyanurate foams, that are associated with lower λ values at lower temperatures, preferably at temperatures <10° C., compared to conventional foams.

It has now been found that, surprisingly, the use of particular polyether siloxanes enables the provision of corresponding polyurethane or polyisocyanurate foams, especially rigid polyurethane or polyisocyanurate foams, and hence enables the solution of the aforementioned problem.

To solve the problem, the invention provides a process for producing polyurethane foam, preferably rigid polyurethane foam, by reacting at least one polyol component with at least one isocyanate component in the presence of at least one blowing agent and of one or more catalysts that catalyze the isocyanate-polyol and/or isocyanate-water reactions and/or the isocyanate trimerization, wherein the reaction is conducted in the presence of polyether-siloxane copolymer of the formula (I)

MₐD_{b}D′_{c} (I)
where

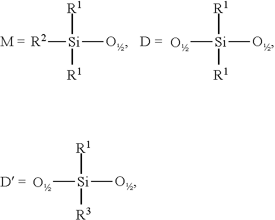

R¹=independently identical or different hydrocarbyl radicals having 1 to 16 carbon atoms or H, preferably methyl, ethyl, propyl and phenyl, especially preferably methyl,

R²=independently le or R³, especially R²=R³,

R³=independently identical or different polyether radicals, preferably polyether radicals of the general formula (II),

—R⁴O[C₂H₄O]_{d}[C₃H₆O]ₑR⁵ (II),

R⁴=identical or different divalent hydrocarbyl radicals which have 1 to 16 carbon atoms and may optionally be interrupted by oxygen atoms, preferably a radical of the general formula (III)

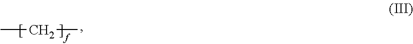

with f=1 to 8, preferably 3,

R⁵=independently identical or different hydrocarbyl radicals which have 1 to 16 carbon atoms and may optionally be interrupted by urethane functions, —C(O)NH—, carbonyl functions or —C(O)O—, or H, preferably methyl, —C(O)Me or H,

with

a=2,

a+b+c=10 to 200, preferably 20 to 80, especially preferably 20 to 50,

b/c=7 to 60, preferably 10 to 50, especially preferably 15 to 50,

d and e=numerical mean values which arise from the following provisos: with the provisos

that the molar mass (numerical average Mₙ) of the individual polyether radicals R³=600 to 2000 g/mol, preferably 700 to 1800 g/mol, especially preferably 800 to 1700 g/mol, that at least one R³ radical present has a molar mass formed to an extent of 27% to 60% by mass, preferably to an extent of 30% to 50% by mass and especially preferably to an extent of 35% to 45% by mass from —[C₃H₆O]— units,

that the percentage siloxane content (i.e. the siloxane backbone without the polyether units) in the polyether-siloxane copolymer is 35% to 60% by mass, preferably 40% to 60% by mass, especially preferably 45% to 55% by mass;

more particularly, the following conditions are fulfilled: c >0, b is in the range from 1 to 194, c is in the range from 1 to 25, d is in the range from 5 to 33, e is in the range from 2.5 to 20.

The present invention also provides for the use of polyurethane foam according to the invention, especially rigid polyurethane foam, for thermal insulation in cooling technology, especially in refrigerators and/or freezers, for thermal insulation in the construction sector, preferably as an insulation panel or sandwich element, for pipe insulation, as a sprayable foam, for insulation of vessel and/or tank walls for cryogenic storage at temperatures <−50° C., for insulation of vessel and/or tank walls for cold storage at temperatures of −50° C. to 20° C., as a constituent of cryogenic insulation systems, preferably liquefied gas tanks or conduits, especially tanks or conduits for automotive gas (LPG), liquid ethylene (LEG) or liquefied natural gas (LNG), for insulation of cooled containers and refrigerated trucks, and for the use as insulation and/or filler material in the form of sprayable foam which is applied directly to the surface to be insulated and/or filled and/or introduced into appropriate cavities.

The present invention is described hereinafter by way of example, without any intention of limiting the invention to these illustrative embodiments. When ranges, general formulae or classes of compounds are specified below, these are intended to encompass not only the corresponding ranges or groups of compounds which are explicitly mentioned but also all subranges and subgroups of compounds which can be derived by leaving out individual values (ranges) or compounds. Where documents are cited in the context of the present description, their content shall fully form part of the disclosure content of the present invention, particularly in respect of the matters referred to. Average values indicated in what follows are number averages, unless otherwise stated. Unless otherwise stated, measurements were carried out at room temperature and standard pressure.

Siloxane compounds are identifiable using a condensed system of nomenclature known as “MDTQ” nomenclature among those skilled in the art. In this system, the siloxane is described according to the presence of the various siloxane monomer units which construct the silicone. The meanings of individual abbreviations in the present document are more particularly elucidated in the present description.

The parameters of polyether siloxanes are determinable by the customary methods known to a person skilled in the art. One example is nuclear spin resonance spectroscopy (NMR spectroscopy). For details for performing the analysis and the evaluation, reference is made to the publication EP 2465892 A1 NMR), the chapter “Silicones in Industrial Applications” in “Inorganic Polymers” from Nova Science Publisher, 2007 (ISBN: 1-60021-656-0) and “Frank Uhlig, Heinrich Chr. Marsmann: ²⁹Si NMR—Some Practical Aspects” in the catalogue “Silicon compounds: Silanes and Silicones” from Gelest, Inc. (²⁹Si NMR). The polyether molar mass Mₙ can be determined, for example, by means of gel permeation chromatography.

The polyether siloxanes for use in the process according to the invention are in principle obtainable according to the prior art processes for preparing polyether siloxanes. More detailed descriptions and more specific references with regard to the possible synthesis routes can be found, for example, in EP 2465892 A1.

The amount of the polyether siloxanes of the formula I used as foam stabilizers in the process according to the invention, expressed as a proportion by mass, based on 100 parts by mass of polyol component (pphp), is from 0.1 to 10 pphp, preferably from 0.5 to 5 pphp, especially preferably from 1 to 3 pphp.

The person skilled in the art knows which substances are suitable as isocyanate component, isocyanate-reactive component, urethane and/or isocyanurate catalysts, flame retardants and blowing agents, and which water contents and indices are suitable, and will also be able to infer such details from the prior art, for example from the publication DE 102010063241 A1.

Suitable isocyanate-reactive components for the purposes of the present invention are all organic substances having one or more isocyanate-reactive groups, preferably OH groups, and also formulations thereof. Preference is given to polyols, specifically all those polyether polyols and/or polyester polyols and/or hydroxyl-containing aliphatic polycarbonates, especially polyether polycarbonate polyols, and/or polyols of natural origin, known as “natural oil-based polyols” (NOPs) which are customarily used for producing polyurethane systems, especially polyurethane coatings, polyurethane elastomers or especially foams. The polyols usually have a functionality of from 1.8 to 8 and number average molecular weights in the range from 500 to 15 000. The polyols having OH numbers in the range from 10 to 1200 mg KOH/g are usually employed.

For production of rigid PU foams, it is possible with preference to use polyols or mixtures thereof, with the proviso that at least 90 parts by weight of the polyols present, based on 100 parts by weight of polyol component, have an OH number greater than 100, preferably greater than 150, especially greater than 200.

The isocyanate components used are preferably one or more organic polyisocyanates having two or more isocyanate functions. Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Isocyanates are more preferably used in a range of from 60 to 200 mol %, relative to the sum total of isocyanate-consuming components.

A preferred ratio of isocyanate and isocyanate-reactive component, expressed as the index of the formulation, i.e. as stoichiometric ratio of isocyanate groups to isocyanate-reactive groups (e.g. OH groups, NH groups) multiplied by 100, is in the range from 10 to 1000 and preferably in the range from 40 to 350. An index of 100 represents a molar reactive group ratio of 1:1.

Catalysts which are suitable for the purposes of the present invention are all compounds which are able to accelerate the reaction of isocyanates with OH functions, NH functions or other isocyanate-reactive groups. It is possible here to make use of the customary catalysts known from the prior art, including, for example, amines (cyclic, acyclic; monoamines, diamines, oligomers having one or more amino groups), organometallic compounds and metal salts, preferably those of tin, iron, bismuth and zinc. In particular, it is possible to use mixtures of a plurality of components as catalysts.

It is possible to work with chemical and/or physical blowing agents. The choice of the blowing agent here depends greatly on the type of system.

According to the amount of blowing agent used, a foam having high or low density is produced. For instance, foams having densities of 5 kg/m³ to 900 kg/m³ can be produced. Preferred densities are 8 to 800, more preferably 10 to 600 kg/m³, especially 30 to 150 kg/m³.

Physical blowing agents used may be corresponding compounds having appropriate boiling points. It is likewise possible to use chemical blowing agents which react with NCO groups to liberate gases, for example water or formic acid. Blowing agents are, for example, liquefied CO₂, nitrogen, air, volatile liquids, for example hydrocarbons having 3, 4 or 5 carbon atoms, preferably cyclopentane, isopentane and n-pentane, hydrofluorocarbons, preferably HFC 245fa, HFC 134a and HFC 365mfc, chlorofluorocarbons, preferably HCFC 141b, hydrofluoroolefins (HFOs) or hydrohaloolefins, for example trans-1-chloro-3,3,3-trifluoropropene (Solstice® 1233zd (E) from Honeywell), or cis-1,1,1,4,4,4-hexafluoro-2-butene (Opteon® 1100 HFO-1336mzz-Z from Chemours/DuPont), oxygen compounds such as methyl formate, acetone and dimethoxymethane, or chlorinated hydrocarbons, preferably dichloromethane and 1,2-dichloroethane.

DE 102010063241 A1 cites even more detailed literature references, to which explicit reference is hereby made.

For production of the polyurethane or polyisocyanurate foam in the process according to the invention, preference is given to using compositions obtainable by combination of two or more separate components. In this context, one of the components is the isocyanate-reactive component (generally referred to as the “A component”, in the American region also as the “B component”) and the other component is the isocyanate component (generally referred to as the “B component”, in the American region also as the “A component”). In general, the isocyanate-reactive component comprises, as a mixture, the polyether siloxane(s) used as foam stabilizer(s) and the further additives such as flame retardant, blowing agent, catalysts, water etc.

As further additives, it is possible to use all substances which are known from the prior art and are used in the production of polyurethanes, especially polyurethane foams, for example crosslinkers and chain extenders, stabilizers against oxidative degradation (known as antioxidants), surfactants, biocides, cell-refining additives, cell openers, solid fillers, antistatic additives, nucleating agents, thickeners, dyes, pigments, color pastes, fragrances, and emulsifiers etc.

Through the process according to the invention, it is possible to obtain polyurethane or polyisocyanurate foams, preferably rigid foams. In particular, the compositions of the present invention are useful for production of molded polyurethane or polyisocyanurate foam bodies. The process according to the invention more preferably includes the use of a spray foam apparatus or a mixing head in conjunction with a high- or low-pressure foaming machine. The foams obtained can be produced in all continuous or batchwise processes and the foam obtained can be processed further. This includes, for example, production in the form of a slabstock foam, on twin-belt laminators, by injection into a cavity and use as an insulation material in cooling technology (for example in cooling cabinets, refrigerators, in the automotive industry, liquefied gas transportation, etc.), in insulation and construction technology (for example as an insulation panel, composite element with flexible or rigid outer layers, or in the form of a sprayable insulation foam), and in further applications, for instance as a construction or adhesive material.

The invention further provides a polyurethane foam, especially rigid polyurethane foam, obtainable by a process according to the invention as described above. In a preferred embodiment, it is a feature of the polyurethane foam that the closed cell content is ≥80%, preferably ≥90%, the closed cell content being determined according to DIN ISO 4590.

The invention further provides a method of lowering the thermal conductivity of polyurethane foams, especially rigid polyurethane foams, in the temperature range of −200° C. to 10° C., preferably −50° C. to 10° C., especially −20° C. to 10° C., by using polyether-siloxane copolymer of the formula (I) in the production of the polyurethane foam, preferably in an amount of 0.1 to 10 parts, preferably of 0.5 to 5 parts, especially preferably of 1 to 3 parts, based on 100 parts of isocyanate-reactive polyol component, where the addition can be effected before and/or during the production of the polyurethane foam.

The invention further provides for the use of polyether-siloxane copolymer of the formula (I) for production of polyurethane foams, especially rigid polyurethane foams, having improved insulation performance within the temperature range of −200° C. to 10° C., preferably −50° C. to 10° C., especially −20° C. to 10° C.

For an even more detailed description, including more specific literature, of preferred typical formulations, possible processing and use examples of the foam obtainable and products producible therewith, reference is made, for example, to documents EP 2465892 A1, DE 102010063241 A1 and WO 2009092505 A1.

The examples adduced hereinafter describe the present invention by way of example, without any intention that the invention, the scope of application of which is apparent from the entirety of the description and the claims, be restricted to the embodiments specified in the examples.

### EXAMPLES

Rigid polyurethane foams have been produced in order to examine the use of various inventive and noninventive foam stabilizers in the process claimed. For this purpose, the formulation according to Table 1 was used.

TABLE 1

| No. | Component | | | | Function | Parts used | | | |
|---|---|---|---|---|---|---|---|---|---|
| 1 | Stepanpol ® PS 2352 | | | | Polyol | 100.0 | | | |
| 2 | Tris(2-chloroisopropyl) phosphate (TCPP) | | | | Flame | 15.0 | | | |
| | | | | | retardant | | | | |
| 3 | KOSMOS ® 75 | | | | Metal | 3.5 | | | |
| | | | | | catalyst | | | | |
| 4 | KOSMOS ® 33 | | | | Metal | 1.0 | | | |
| | | | | | catalyst | | | | |
| 5 | Tegoamin ® PMDETA | | | | Amine | 0.2 | | | |
| | | | | | catalyst | | | | |
| 6 | Water | | | | Blowing | 0.3 | | | |
| | | | | | agent | | | | |
| 7 | n- | iso- | n-/iso- | Solstice ® | Blowing | 20.0 | 20.0 | 20.0 | 36.2 |
| | pentane | pentane | pentane | 1233zd | agent | | | | |
| | | | (50:50%) | (E) | | | | | |

| | | | |
|---|---|---|---|
| 8 | Stabilizer 1-8 | Foam | 2.0 |
| | | stabilizer | |
| 9 | Lupranate ® M70L | Isocyanate | 180.0 |

The foaming operations were conducted with a KraussMaffei RIM-Star MiniDos high-pressure foaming machine with a MK12/18ULP-2KVV-G-80-I mixing head, and a KraussMaffei Microdos additive dosage system. Components 1-7 were in the polyol reservoir vessel; the foam stabilizer 8 was dosed directly into the polyol stream in the mixing head with the Microdos dosage system. The use temperature of the polyol blend was 30° C., that of the isocyanate component 9 was 25° C., and isocyanate/polyol blend ratio was 1.268. The liquid foam mixture was injected into a metal mold having internal dimensions of 50 cm·50 cm·5 cm that had been heated to 40° C. and left therein until the foam had set. Two specimens having dimensions of 20 cm·20 cm·0.5 cm were cut out of the foam molding thus obtained and used for the measurements of the thermal conductivities. The λ values used are each averages from these two measurements. The thermal conductivities of the specimens were measured in a LaserComp Heat Flow Meter instrument.

The stabilizers used for the examples are listed in Table 2.

TABLE 2

| | | | | | | % by wt. of | | % by wt. of |
|---|---|---|---|---|---|---|---|---|
| | Inventive? | R² | a + b + c | b/c | Mₙ of R³ | PO in R³ | R⁵ | siloxane |
| Stabilizer 1 | yes | R³ | 50 | 15 | 1000 | 40 | H | 42 |
| Stabilizer 2 | yes | CH₃ | 30 | 10 | 1000 | 40 | CH₃ | 46 |
| Stabilizer 3 | yes | CH₃ | 30 | 15 | 1000 | 40 | H | 56 |
| Stabilizer 4 | yes | CH₃ | 30 | 10 | 700 | 40 | H | 55 |
| Stabilizer 5 | yes | R³ | 30 | 30 | 700 | 40 | H | 52 |
| Stabilizer 6 | no | CH₃ | 50 | 5 | 700 | 40 | H | 39 |
| | (comparative) | | | | | | | |
| Stabilizer 7 | no | CH₃ | 50 | 10 | 700 | 20 | H | 55 |
| | (comparative) | | | | | | | |
| Stabilizer 8 | no | CH₃ | 30 | 10 | 700 | 0 | H | 55 |
| | (comparative) | | | | | | | |

### Example 1

The formulation from Table 1 was foamed as specified therein with 20 parts n-pentane as blowing agent. The foam stabilizers used were stabilizers 2, 3 and 5 (inventive), and stabilizers 6 and 7 were used as noninventive comparative examples. The measurements for temperature-dependent thermal conductivities shown in table 3 (all thermal conductivity figures in mW/m·K) were obtained.

TABLE 3
(all thermal conductivity figures in mW/m · K)

| | Temperature (° C.) | | | | | | | | | |
|---|---|---|---|---|---|---|---|---|---|---|
| | −5 | 0 | 5 | 10 | 15 | 20 | 25 | 30 | 35 | 40 |
| Stabilizer 2 (inv.) | 24.28 | 22.87 | 21.69 | 21.72 | 21.81 | 22.12 | 22.34 | 22.71 | 22.88 | 23.19 |
| Stabilizer 3 (inv.) | 24.02 | 22.74 | 21.65 | 21.63 | 21.76 | 21.93 | 22.21 | 22.53 | 22.70 | 22.96 |
| Stabilizer 5 (inv.) | 23.67 | 22.69 | 21.53 | 21.57 | 21.73 | 22.10 | 22.28 | 22.51 | 22.71 | 23.09 |
| Stabilizer 6 (comp.) | 24.41 | 23.51 | 22.41 | 21.79 | 21.91 | 22.20 | 22.42 | 22.67 | 22.81 | 23.21 |
| Stabilizer 7 (comp.) | 24.39 | 23.53 | 22.51 | 21.85 | 21.87 | 22.24 | 22.47 | 22.59 | 22.75 | 23.14 |

It can be inferred from the table that the foams produced with the inventive foam stabilizers 2, 3 and 5 have lower thermal conductivity with decreasing measurement temperature than the foams comprising the noninventive stabilizers 6 and 7. The minimum of the thermal conductivity plot has moved to lower temperatures and a better insulation performance at comparable temperature is obtained.

### Example 2

The formulation from Table 1 was foamed as specified therein with 20 parts isopentane as blowing agent. The foam stabilizers used were candidates 1 and 4 (inventive) and candidate 8 as a noninventive comparative example. The measurements for temperature-dependent thermal conductivities shown in table 4 (all thermal conductivity figures in mW/m·K) were obtained.

TABLE 4
(all thermal conductivity figures in mW/m · K)

| | Temperature (° C.) | | | | | | | | | |
|---|---|---|---|---|---|---|---|---|---|---|
| | −5 | 0 | 5 | 10 | 15 | 20 | 25 | 30 | 35 | 40 |
| Stabilizer 1 (inv.) | 24.1 | 22.57 | 21.53 | 21.54 | 21.67 | 22.02 | 22.13 | 22.51 | 22.75 | 22.88 |
| Stabilizer 4 (inv.) | 23.85 | 22.44 | 21.41 | 21.50 | 21.59 | 21.84 | 22.18 | 22.43 | 22.61 | 22.81 |
| Stabilizer 8 (comp.) | 24.33 | 23.48 | 22.21 | 21.67 | 21.83 | 22.11 | 22.24 | 22.53 | 22.74 | 22.95 |

It can be inferred from the table that the foams produced with the inventive foam stabilizers 1 and 4 have lower thermal conductivity with decreasing measurement temperature than the foams comprising the noninventive stabilizer 8. The minimum of the thermal conductivity plot has moved to lower temperatures and a better insulation performance at comparable temperature is obtained.

### Example 3

The formulation from Table 1 was foamed as specified therein with 20 parts of a mixture of 50% n-pentane and 50% isopentane as blowing agent. The foam stabilizers used were candidates 2, 3 and 5 (inventive), and candidates 6 and 7 were used as noninventive comparative examples. The measurements for temperature-dependent thermal conductivities shown in table 5 (all thermal conductivity figures in mW/m·K) were obtained.

TABLE 5
(all thermal conductivity figures in mW/m · K)

| | Temperature (° C.) | | | | | | | | | |
|---|---|---|---|---|---|---|---|---|---|---|
| | −5 | 0 | 5 | 10 | 15 | 20 | 25 | 30 | 35 | 40 |
| Stabilizer 2 (inv.) | 23.89 | 22.69 | 21.52 | 21.55 | 21.69 | 22.00 | 22.19 | 22.62 | 22.71 | 23.05 |
| Stabilizer 3 (inv.) | 23.94 | 22.7 | 21.55 | 21.51 | 21.62 | 21.85 | 22.21 | 22.52 | 22.65 | 22.81 |
| Stabilizer 5 (inv.) | 23.57 | 22.61 | 21.49 | 21.45 | 21.58 | 22.01 | 22.28 | 22.51 | 22.55 | 23.04 |
| Stabilizer 6 (comp.) | 24.35 | 23.21 | 22.52 | 21.69 | 21.77 | 22.01 | 22.32 | 22.56 | 22.81 | 23.02 |
| Stabilizer 7 (comp.) | 24.28 | 23.5 | 22.59 | 21.81 | 21.81 | 21.97 | 22.37 | 22.52 | 22.63 | 23.08 |

It can be inferred from the table that the foams produced with the inventive foam stabilizers 2, 3 and 5 have lower thermal conductivity with decreasing measurement temperature than the foams comprising the noninventive stabilizers 6 and 7. The minimum of the thermal conductivity plot has moved to lower temperatures and a better insulation performance at comparable temperature is obtained.

### Example 4

The formulation from Table 1 was foamed as specified therein with 36.2 parts Solstice® 1233zd (E) from Honeywell as blowing agent. The foam stabilizers used were candidates 1, 2 and 4 (inventive), and candidates 6 and 7 were used as noninventive comparative examples. The measurements for temperature-dependent thermal conductivities shown in table 6 (all thermal conductivity figures in mW/m·K) were obtained.

TABLE 6
(all thermal conductivity figures in mW/m · K)

| | Temperature (° C.) | | | | | | | | | |
|---|---|---|---|---|---|---|---|---|---|---|
| | −5 | 0 | 5 | 10 | 15 | 20 | 25 | 30 | 35 | 40 |
| Stabilizer 1 (inv.) | 18.78 | 17.59 | 17.5 | 17.82 | 18.33 | 18.83 | 19.21 | 19.47 | 19.8 | 20.08 |
| Stabilizer 2 (inv.) | 18.95 | 17.5 | 17.52 | 18.03 | 18.42 | 18.74 | 19.01 | 19.37 | 19.66 | 19.95 |
| Stabilizer 4 (inv.) | 19.11 | 17.47 | 17.61 | 17.92 | 18.35 | 18.78 | 18.98 | 19.53 | 19.76 | 19.99 |
| Stabilizer 6 (comp.) | 19.62 | 18.29 | 17.88 | 17.96 | 18.4 | 18.7 | 19.1 | 19.45 | 19.69 | 19.89 |
| Stabilizer 7 (comp.) | 19.76 | 18.17 | 17.83 | 17.87 | 18.31 | 18.69 | 18.85 | 19.55 | 19.86 | 20.13 |

It can be inferred from the table that the foams produced with the inventive foam stabilizers 1, 2 and 4 have lower thermal conductivity with decreasing measurement temperature than the foams comprising the noninventive stabilizers 6 and 7. The minimum of the thermal conductivity plot has moved to lower temperatures and a better insulation performance at comparable temperature is obtained.

1. A process for producing polyurethane foam by reacting at least one polyol component with an isocyanate component in the presence of a blowing agent and of one or more catalysts that catalyze the isocyanate-polyol and/or isocyanate-water reactions and/or the isocyanate trimerization, wherein the reaction is conducted in the presence of polyether-siloxane copolymer of the formula (I)
MₐD_{b}D′_{c} (I)
with 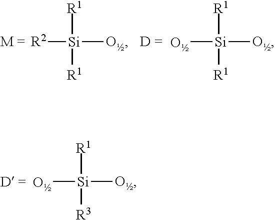
R¹=independently identical or different hydrocarbyl radicals having 1 to 16 carbon atoms or
H,
R²=independently R¹ or R³,
R³polyether radicals of the general formula (II),
—R⁴O[C₂H₄O]_{d}[C₃H₆O]ₑR⁵ (II),
R⁴=identical or different divalent hydrocarbyl radicals which have 1 to 16 carbon atoms and may be interrupted by oxygen atoms,
CH₂_{f}
R⁵=independently identical or different hydrocarbyl radicals which have 1 to 16 carbon atoms and may optionally be interrupted by urethane functions, —C(O)NH—, carbonyl functions or —C(O)O—, or H, preferably methyl, —C(O)Me or H,
with
a=2,
a+b+c=10 to 200,
b/c=7 to 60,
d and e=numerical mean values which arise from the following provisos:
with the provisos
that the molar mass (numerical average Mₙ) of the individual polyether radicals R³=600 to 2000 g/mol,
that at least one R³ radical present has a molar mass formed to an extent of 27% to 60% by mass, from —[C₃H₆O]— units,
that the percentage siloxane content in the polyether-siloxane copolymer is 35% to 60% by mass, by mass.

2. The process according to claim 1, wherein R²=R³.

3. The process according to claim 1, wherein the polyurethane foam is a rigid polyurethane foam.

4. The process according to claim 1, wherein the polyether siloxanes of the formula I are used in a total proportion by mass of 0.1 to 10 parts based on 100 parts by mass of polyol component.

5. The process according to claim 1, wherein at least 90 parts by weight of the polyols present, based on 100 parts by weight of polyol component, have an OH number greater than 100.

6. The process according to claim 1, wherein hydrocarbons having 3, 4 or 5 carbon atoms, such as, cyclo-, iso- and/or n-pentane, hydrofluorocarbons, hydrochlorofluorocarbons, hydrohaloolefins.

7. The polyurethane foam, especially rigid polyurethane foam, obtainable by a process according to claim 1.

8. The polyurethane foam according to claim 7, wherein the closed cell content is ≥80%, preferably the closed cell content being determined according to DIN ISO 4590.

9. A thermal insulation for cooling technology comprising the polyurethane foam according to claim 7 wherein the thermal insulation is used in cooling technology selected from the group consisting of refrigerators, freezers,
an insulation panel, sandwich element,
pipe insulation,
vessel, tank walls for cryogenic storage at temperatures <−50° C.,
for insulation of vessel and/or tank walls for cold storage at temperatures of −50° C. to 20° C.,
as a constituent of cryogenic insulation systems, liquefied gas tanks or conduits, tanks or conduits for automotive gas (LPG), liquid ethylene (LEG) or liquefied natural gas (LNG).

10. The thermal insulation according to claim 9 in the form of sprayable foam, which is applied directly to the surface to be insulated and/or filled and/or introduced into appropriate cavities.

11. A method of lowering the thermal conductivity of polyurethane foams, especially rigid polyurethane foams, in the temperature range of −200° C. to 10° C., by using polyether-siloxane copolymer of the formula (I) in the production of the polyurethane foam, in an amount of 0.1 to 10 parts, based on 100 of parts isocyanate-reactive polyol component, where the addition can be effected before and/or during the production of the polyurethane foam.

12. A rigid polyurethane foam made by the process of claim 1 wherein the rigid polyurethance foam has improved insulation performance within the temperature range of −200° C. to 10° C.

13. The process according to claim 1 wherein
R¹=methyl,
R⁴=a radical of the general formula (III)
CH₂_{f} (III),
with f=1 to 8,
a+b+c=20 to 50,
b/c=15 to 50,
d and e=numerical mean values which arise from the following provisos:
with the provisos
that the molar mass (numerical average Mₙ) of the individual polyether radicals R³=800 to 1700 g/mol,
that at least one R³ radical present has a molar mass formed to an extent of 35% to 45% by mass from —[C₃H₆O]— units,
that the percentage siloxane content in the polyether-siloxane copolymer is 45% to 50% by mass.

14. The process according to claim 1, wherein the polyether siloxanes of the formula I are used in a total proportion by mass of 1 to 3 parts, based on 100 parts by mass of polyol component.

15. The process according to claim 1, wherein at least 90 parts by weight of the polyols present, based on 100 parts by weight of polyol component, have an OH number greater than 200.

16. The process according to claim 1, wherein at least 90 parts by weight of the polyols present, based on 100 parts by weight of polyol component, have an OH number greater than 150.

17. The process according to claim 1, further comprising a blowing agent selected from the group consisting of n-pentane, hydrofluorocarbons, hydrochlorofluorocarbons, and hydrohaloolefins.

18. The process according to claim 1, further comprising a blowing agent selected from the group consisting of trans-l-chloro-3,3,3-trifluoropropene and cis-1,1,1,4,4,4-hexafluoro-2-butene.

19. The process according to claim 1, further comprising a blowing agent selected from the group consisting of methyl formate, acetone, dimethoxymethane, dichloromethane and 1,2-dichloroethane.

20. The polyurethane foam according to claim 7, wherein the closed cell content is ≥90% the closed cell content being determined according to DIN ISO 4590.
